(19) United States
(12) Patent Application Publication
(10) Pub. No.: US 2014/0143304 A1
(43) Pub. Date: May 22, 2014

(54) USER INTERACTION MONITORING

(71) Applicant: WONGA TECHNOLOGY LIMITED, (US)

(72) Inventors: Daniel Hegarty, London (GB); Larry Shapiro, London (GB); Nikola Sivacki, London (GB)

(73) Assignee: WONGA TECHNOLOGY LIMITED, Dublin (IE)

(21) Appl. No.: 13/840,951

(22) Filed: Mar. 15, 2013

(30) Foreign Application Priority Data
Nov. 22, 2012 (GB) 1221076.1

(51) Int. Cl. H04L 29/06

(52) U.S. Cl. CPC H04L 67/42
USPC 709/203

(57) ABSTRACT

A system and method for monitoring the interaction of a user using a client device with a page of a remote server. The client device includes a processor, memory and a computer program stored in the memory. The computer program can be executed on the processor, such that the processor causes the client device to record user interactions with components on the page of the remote server; to extract for each interaction a unique ID value for the component with which the interaction occurred; to create event data derived from each interaction comprising the unique ID value and at least a time value for each interaction; and to transmit the event data as a stream to the remote server.

### BACKGROUND OF THE INVENTION

This invention relates to methods and systems for monitoring user interactions with computers or with mobile devices including, for example, tablet devices, smartphones, and the like, particularly for online use such as interacting with websites.

The way that a user interacts with a website can often provide useful (and predictive) information about them. For example, copying and pasting information into a website form could be indicative that the user does not know the information so pasted. Depending upon the field of a website into which the information is pasted, this could indicate fraudulent activity. Other interactions such as successive refinements of key fields to try to “game” a system or reverse engineer logic embedded within a website, may also be detected by monitoring user interactions.

In general, in addition to the final set of data entered by a user into a website, data about the user input process may be collected, covering items like mouse behaviour, dwell time, order of entering fields, and so on. This data can then be transmitted to a website provider and can be used as part of a decision process such as authenticating a user or providing other security checks.

Systems are known that monitor mouse or keyboard entries. US 2010/0138370 describes a system in which users are profiled using rules based on machine-learning. U.S. Pat. No. 7,860,870 describes a system for determining whether data represents abnormal activity. U.S. Pat. No. 7,092,926 describes analysing click stream patterns to identify a current user of a system.

### SUMMARY OF THE INVENTION

We have appreciated that monitoring of user interactions with devices may be improved. In particular, we have appreciated that the reporting of interactions with websites should be improved.

A system embodying the invention may operate a method of reporting interactions between client devices and website by reporting interactions as events, with each event having an event ID.

In a first aspect, each component on a web page is assigned a unique ID number, and each interaction with a component is reported as an event, the data for an event preferably includes at least the unique ID number of the component with which interaction occurred and a timestamp. The use of a unique ID for each of the components ensures accurate reporting of interactions and appropriate granularity for subsequent analysis. The event data may be aggregated to derive features of user interactions. The features may be derived at a remote server to which the event data is transmitted. As an alternative, the features may be derived at the client device, and thereby reduce the volume of data to be transmitted.

In a second aspect, the event data is selectively compressed using frequency analysis prior to transmission. This aspect is particularly applicable to monitoring interactions with mobile devices, in particular monitoring continuous sensors such as movement sensors. The digitization of data from a continuous sensor may result in a large volume of data for which bandwidth may not be available, or may be costly. By using lossy compression for some, or all, of a stream of event data, the volume of data may be reduced, whilst taking into account the nature of the data being sent and the acceptable losses.

The aspects of the invention may be used separately or in combination together.

### BRIEF DESCRIPTION OF THE DRAWINGS

The invention will now be described in more detail by way of example with reference to the drawings, in which:

FIG. 1: is a functional diagram of the key components of a system embodying the invention;

FIG. 2: shows the process for assigning unique IDs to components;

FIG. 3: shows data fields for an event related to a component;

FIG. 4: shows a known use of source data;

FIG. 5: shows improved use of source data with event data;

FIG. 6: is a functional diagram showing the compression of event data at a client device; and

FIG. 7: is a flow diagram showing the operation of the compression.

### DETAILED DESCRIPTION OF THE PREFERRED EMBODIMENTS

The monitoring of user interactions with client devices such as desktop computers, mobile devices, tablets, smartphones and the like has advantages in relation to providing security and authentication of users and in detecting fraudulent activities. The nature of user interactions varies depending upon the type of device used. For a desktop PC, interactions include keyboard presses and mouse clicks and information may be derived from the manner in which a user types or uses a mouse. For mobile devices, user interactions include inputs such as selections on a touch screen, scrolling, zooming, copying and pasting as well as indirect information such as movement of the mobile device and any other change of environment that may be sensed by the sensors within the mobile device.

The nature of interactions with a website or with a mobile application has some similarities and some differences. A mobile application or mobile browser may both interact with fields displayed to a user such that the interactions may be recorded either at the mobile device or at the web server. Additionally, a mobile application may record peripheral information such as motion, temperature or other environmental factors at the same time as recording user input.

A further issue arises with mobile devices relating to bandwidth for transmission of data relating to user interactions to a server. Every interaction transmitted to a server will use bandwidth and the granularity of data sent to a server is ideally as fine as possible, but this increases the bandwidth used.

Common to both mobile and desktop applications is the need to appropriately identify user interactions and the sampling of other data.

In the embodiments of the invention described, each component on a web page is assigned a unique identification number for that page. A combination of an identifier for the page itself and the unique identification number of each component on the page allows identification of each of the components on all pages making up a given website. The unique identification numbers may be as simple as sequential integers on a given page or may comprise a more complex coding scheme. The important point is that each component on a webpage may be uniquely identified.

The nature of components on webpages includes input fields, graphics and any parts of a webpage that may be separately defined within the webpage construction. The use of such unique identifications is unlike prior systems which rely upon the existing underlying mark-up language as the mechanism to identify components.

The sampling of data from client devices may be defined as “events” with each “event” being an instance of an interaction with the device by a user or a sampled part of a continuous process. For example, one event is a mouse click in a particular component on a webpage. Another example of an event is the sampling of distance moved in a particular time period using a GPS chip within a mobile device. The use of such an event sampling approach allows for an efficient way of processing and communicating data. Considering the nature of user interactions on webpages, events may include interactions with components on webpages and may be recorded as event data including the identification of the component on the webpage, the nature of the event, a time stamp and some categorisation of the event type. As a user interacts with a webpage, events may be continually recorded and either manipulated at the client device or transmitted in their raw form direct to a server for further analysis.

The event approach to data collection allows for efficient analysis of the events and also a way of compressing data for transmission as will be described later. In broad terms, events may be analysed by gathering together events in a particular period of time to determine “features” of interactions. A feature is a less granular type of information than events data and may be considered as the aggregation of events of a given period of time so as to derive further information about interactions. Features may be reported as feature data including a feature ID, time stamp, session ID and a relative time indicator. The session ID of a user connection is the process by which information for events may be gathered together and linked, for example, to a user account for the user interacting with a website.

The following are examples of user events that may be captured by the system.
Mouse click
Mouse move
Mouse hover change
Keyboard press-down
Keyboard press-up
Focus change
Scroll
Mouse text select
Keyboard Edit: Copy, Paste, Cut, SelectAll

System Overview

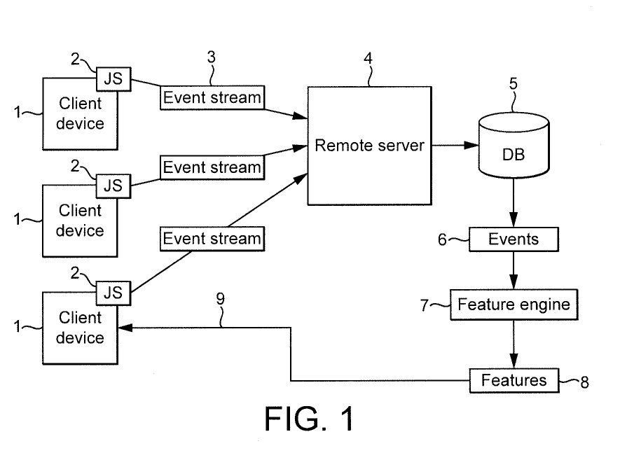

The main functional components of a system embodying the invention are shown in FIG. 1. Client devices 1 communicate with a remote server 4 via communication paths 3. The communication path 3 may be a wired or wireless path depending upon the nature of the client device 1. Each client device 1 has a browser for browsing websites provided by the remote server 4 or via a separate server. Each client device 1 includes a separate functional unit which may be defined as an interaction monitor or module 2 here shown as a JavaScript (JS) module that integrates with the web application and monitors interaction to produce event data. The interaction modules 2 of each device reports the event data as an event stream over the communication paths 3 to the remote server 4.

Although described here as a browser with a JavaScript module, the embodiment of the client device may equally comprise an application (mobile or web, or a mobile native app). The JavaScript module may, in some embodiments, derive “features” from the event data, as discussed later, in which case the compression aspects of the invention may not be needed. The arrangements of this disclosure cover all of these alternatives.

The function of the remote server 4 may be dedicated to providing the “click service”, namely the reception and processing of event streams, or may provide other functions such as providing the website itself being viewed by the user devices. The click service at the remote server 4 receives the event streams and reports these to a database 5 into which the event data is populated for all users. The event data may then be manipulated in a variety of ways. One such way is to provide the events (shown schematically as box 6 in FIG. 1) over a communication path to a processor 7 referred to as a feature engine, which is a module arranged to process the event data by aggregating events for one user or across multiple users into features which may be output as feature information at (shown schematically as box 8 in FIG. 1).

In more detail, the JavaScript file 2 is included in the web application, which attaches itself to the various components on the page, installing event listeners and initializing the appropriate session ID. The client device 1 buffers the events and sends them grouped into batches of N (‘packets’) to the remote server 4. Each event stream packet consists of a list of events captured in the browser, corresponding to user behaviour, such as mouse movement, keyboard activity, and so on. These events are optionally compressed and obfuscated. User sensitive data may also be masked.

The click stream is associated with a session ID and page ID, linking the user's session to the page on which the behaviour is being tracked. The event stream is sent via HTTP POST to the remote server 4 which then writes them into a database 5.

Component ID

The nature of events and components will now be described in greater detail. As previously described, an advantage provided by the embodiment is that each component on the web page or application is given a unique component ID. This facilitates the gathering and reporting of events. A component, in this embodiment, is an element of HTML DOM (HTML document object model) that may be tracked by and assigned a unique ID. Such components may (or may not) have a visual representation when the HTML DOM is rendered in a browser. For example, an input field, textbox, button or ‘div’ element on the web page can all be components.

All events have an attached componentID. Some events which are by nature not related to any particular component on the page (such as events from motion sensors) have the componentID of zero (0). This allows events from interactions with components on a web page and events from other sensors to be transmitted using the same protocol. The use of a componentID of zero (0) indicates that the event does not relate to a particular component of the web page.

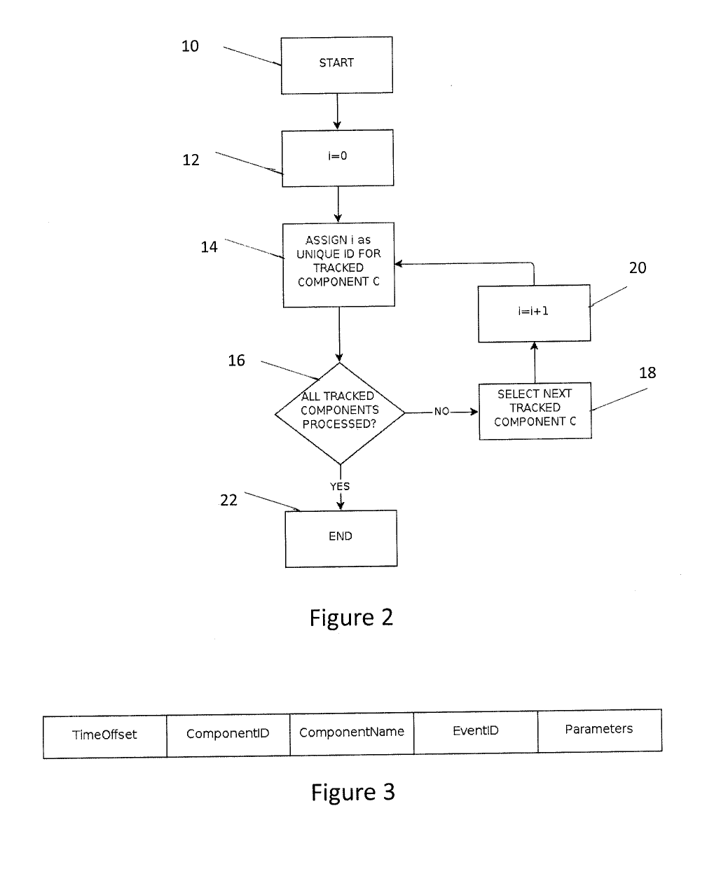

For any web page, the unique IDs of components are preferably created and stored prior to use by the system. The IDs may be inserted by a routine or script in an automated manner as shown in FIG. 2. The script initialization iterates through all HTML elements that are to be tracked and assigns a unique ID to each (by incrementing an integer in the loop). This assignment is implemented by extending the corresponding HTML DOM element with a new attribute that contains the ID. The script is preferably run each time the page is loaded.

As shown in FIG. 2, the script starts at step 10 and initializes a count for the unique ID i=0 at step 12. The first ID i=0 is then assigned to the first component on the page retrieved in order as presented by the document model at step 14. The process then determines whether all components have been processed at step 16 and, if not, the ID is iterated by 1 at step 20 and assigned to the next components retrieved at step 14. This is repeated until it is determined that all components have unique IDs and the process ends at step 22.

As can be seen, the process is iterative and preferably assigns ID values in order of retrieval of components. The IDs may, of course, be more complex and the simple monotonic integer example is one possible approach. The fact that the unique IDs are assigned at runtime on retrieval of the web page works well because the IDs will necessarily be assigned the same values each time as the logic for assigning the values only depends upon the order of the components as defined in the HTML.

The way in which the unique IDs are stored has advantages. The IDs are added as an extension to the markup language and so are available to the interaction module 2 within each client device and no separate storage of transmission of the IDs is needed. The ID is stored in the already existing data structure—the document itself and is present as local data available at the client device 1 when the event on that component is handled. This approach avoids defining a new global memory storage in the client where IDs would be stored and mapped against components. By storing the ID only at the location which is available when handling the event, as an argument of the HTML element, the document is minimally extended for maximum benefit.

An example of a web page component (in hypertext markup language) before script initialization is as follows: <input type=“text” id=“edit-last-name”>

The same web page component (in hypertext markup language) after script initialization (and ID assignment) is as follows:

<input type=“text” id=“edit-last-name”_trid_{—}=“142”>

As can be seen, the last attribute, named ‘_trid_’ is added to each tracked component during script initialization. This way, the page DOM model (in-memory data structure describing the page structure) is extended by the script to store this ID during the lifetime of the page visit. This ID is referenced when encoding the event occurring on that component. For the same page structure, the values of IDs are always the same for their corresponding components, since the elements to be tracked will always be iterated in the same order. Accordingly, running the script each time the page is loaded allows the component IDs to be inserted in the same way each time the page is loaded.

Each event has several fields shared across all event types, such as timestamp (since page load), event location (over which component on the page has the event occurred) and the event type. Other parameters are optional and depend on the event type. The preferred basic structure of the events is as shown in FIG. 3 and comprises a timestamp (TimeOffset), ID of component (ComponentID), name of component (ComponentName), eventID and one or more parameters describing the event.

The following is an example list of parameters that may be used generally.

| EVENT TYPE | PARAMETERS |
|---|---|
| Copy | — |
| Cut | — |
| SelectAll | — |
| Paste | — |
| Select | Selected text |
| Mouse click | Mouse position (x, y) |
| Option Change | Text of new option |
| Key down | Key code, delay since previous key_down |
| Key up | Key code, delay since this key was down |
| Mouse move | Mouse position (x, y) |
| Scroll | x or y-position on the page, page height/ |
| | width |
| Mouse hover change | Mouse position, ID of previous element, |
| | time hovered over the previous element |
| Focus change | ID of previous focused element, time spent |
| | in focus on previous element, total number |
| | of focuses for element, total time spent on |
| | focus |
| Page size event | Width, Height |
| Page resize | new Width, new Height |
| Mouse dragging | Mouse position (x, y) |

The following is an example list of parameters particularly applicable to mobile devices.

| EVENT TYPE | PARAMETERS |
|---|---|
| Touch down | Total number of pointers, index of current |
| | pointer, Pointer position (x, y), pressure, |
| | pointer size |
| Touch up | Total number of pointers, index of current |
| | pointer, Pointer position (x, y), pressure, |
| | pointer size |
| Touch move | Total number of pointers, index of current |
| | pointer, Pointer position (x, y), pressure, |
| | pointer size |
| Acceleration | Acceleration along x, y, z axes |
| Gyroscope | Gyroscope readings along x, y, z axes |
| Illumination | Light intensity |
| Proximity | The proximity of the user to the phone |
| Orientation | Orientation (integer) |
| Rotation | Rotation along three axes (‘pitch’, ‘roll’, |
| | ‘yaw’) |

These basic events may be combined into features, which are used for classifying user behaviour sessions. As previously noted, this may be provided at the client's device, but is preferably performed at a centralised service, here shown as the click service and feature engine.

The click service (of the remote server 4) handles the HTTP-POST requests arriving from the client device 4, and writes the events into the database 5. The feature engine 7 reads the raw events from the database 5, and aggregates the events into features. After having received all events for a page session, the feature calculation module executes algorithms that produce derived features from these events.

For example, a series of events arrives containing, among others, mouse hover and mouse click events. When calculating the ‘Hesitation’ derived feature for a particular component (usually a button), the feature calculation module selects all mouse hover events and all mouse click events for that component and calculates all the differences between timeOffsets of mouse clicks over the component and the preceding mouse hover events over the same component. This delay corresponds to the time the user is hesitating about clicking on a button. These operations of selecting, sorting and matching events in memory based on componentID, eventIDs and timeOffsets, in order to produce features like hesitation can be performed using linear algebra packages, which require data they work with to be to be numerical. This is where each component being automatically assigned a unique ID is an advantage, since it allows for the algorithm to identify the component without resolving to calculating hashes of component names for each event, which would prove time consuming for potentially millions of events arriving to the service every second. As previously noted, the IDs are calculated only once per page load by the user's browser.

Some examples of features will now be described. Different use cases require different types of features for classification purposes. For example, web page layout optimisation would require some different feature from, say, fraud detection. Other applications might require other types of features so the below list may be extended depending upon requirements.

| FEATURE | DESCRIPTION |
|---|---|
| Cursor delta distribution | Distribution of mouse movement pauses, in |
| | 1-second resolution, from 1 sec to 10+ |
| | seconds. |
| Key delta distribution | The distribution of delays between |
| | key_down events |
| Session duration | Duration of the session, in seconds |
| Number of mouse move events | Used for approximating mouse activity |
| Number of scroll events | Used for understanding page motion |
| Maximum mouse dwell time | Length of the longest pause in mouse |
| | activity |
| Hover orders (components) | Takes a set of components as arguments, |
| | gives the index order of hover activity over |
| | each of the component. This can be used |
| | to determine the order in which the |
| | components are hovered. |
| Hesitation (components) | Calculates the delay between the mouse |
| | hovering over a component and the clicking |
| | over the same component |
| Hover count (component) | Total number of hover events over a |
| | component |
| Get Click (position) | Returns 1 if the user has clicked on a |
| | position specified by ‘position’ (x, y) |
| Total drag event count | Total amount of dragging performed |
| Max silence | Maximum length of an interval where no |
| | activity is tracked |
| Distribution of event values (component) | Configurable number of buckets |
| Distribution of event types (component) | |
| Maximum, average value of event | |
| parameter | |
| Total key presses | Total number of key press events |
| Mouse off page intervals (delay) | Number of intervals the user has left the |
| | page for longer than ‘delay’ seconds |
| Total event count at component | Total number of events of type ‘event_type’ |
| (component, event_type) | occurring over ‘component’ |
| Hesitation for a button | This feature is represented by a number of |
| | seconds the user spends hovering the |
| | mouse cursor over a button before clicking |
| | the button |
| Off-screen sessions | This feature represents the number of |
| | times the user has moved the mouse |
| | cursor away from the page. This is |
| | computed by tracking the moment when |
| | the mouse cursor leaves the page (from |
| | any of the four sides) and stays away from |
| | at least 10 seconds, before entering the |
| | page again. |
| Mouse movement deltas | This feature represents a distribution of the |
| | delays between mouse movement events |
| | in values 1 to 10+ seconds. This means |
| | that the feature contains number of times |
| | the pause of mouse activity has been 1 |
| | second, 2 seconds, etc. The feature, |
| | therefore, represents a list of integer |
| | number that represent these counts. |
| Max silence time | The maximum delay, in seconds, during |
| | which no events, from any source, have |
| | been captured. |

The output of the feature analyser is preferably used as part of a wider security system as will be discussed in more detail below. One approach, though, is to provide a direct feedback signal over the communication path to the client device 1 (here shown as feedback line 9 in FIG. 1) to allow or deny further operation or access to data. Another approach is where the features are derived within the client device 1. In such an arrangement, the event data does not need to be transmitted to the remote server 4 and, instead, the client device itself processes the feature data and determines an appropriate outcome. For example, if the event data comprises a sequence of events that show a derived feature of copying and pasting of a user ID of some form, then the client device itself may determine that this behaviour is unallowable and deny further access to the system.

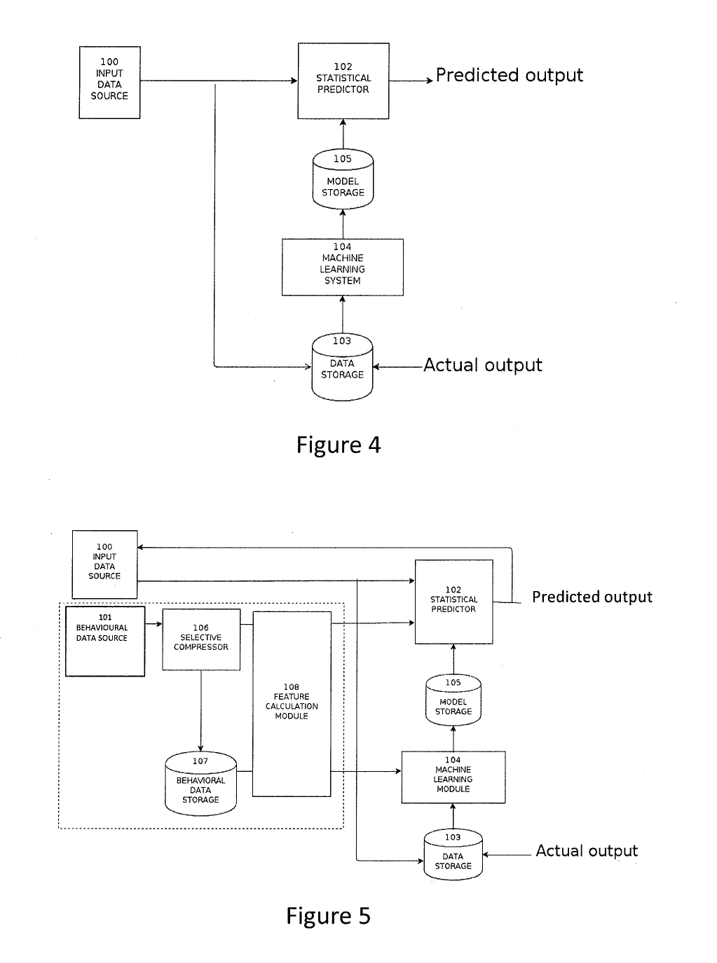

Various examples of how the event data may be used will now be described in greater detail relation to FIGS. 4 and 5.

FIG. 4 shows a known way in which source data relating to a user could be used in the absence of gathering event data. Source data may be any data related to the user such as user id, request for a specific service or other directly input data. Data relating to a user is provided as an input data source 100 to a statistical predictor 102 which analyses the data received to provide a predicted output. The statistical predictor 102 may be a form of risk engine, security engine, authorisation module or similar process which takes data as an input to provide a prediction as an output. The predicted output may be a signal asserted to a separate system to allow or deny access to further systems.

The input data source 100 may also be supplied to data storage 103 that receives the source data as well as data from other sources, referred to as “actual output” that may relate to the user of the client device 1 or to data used as training data more generally. The data is referred to as “actual output” data in the sense that it is data that may have some correlation with the user activity, for example previous attempts to log on to a system, location of the user or other measures of the user's performance in relation to the system. Both the actual output data and the source data are stored in the data storage 103 and provided to a machine learning system 104 which operates statistical analysis on the two groups of data to predict an outcome of activity based upon this available data and supplies this to a model storage 105. The model storage 105 may then supply an input to the statistical predictor module 102 to analyse the supplied data.

FIG. 5 shows an improvement to the above arrangement shown in FIG. 4 in which event data is used in addition to source data relating to a user (elements 101, 106, 107 and 108 in the dotted box). The arrangement of FIG. 5 is an improvement over the previous arrangement in that behavioural data (as supplied by events) may be provided in addition to other source data. This requires additional systems and processes to provide correlation of the behavioural data and primary data in such as a way as to allow timely execution of predictive algorithms in the statistical predictor module 102. This arrangement addresses problems such as the complexity of generated data, the size of generated data with compression and losses acceptable for the target purpose and making event data such as mouse movements and key movements fast to process.

A user of a client device 1 may provide primary data which is entered by the user and may include their user ID, password and so on to identify themselves to the system, here shown as input data source 100. In addition, the behavioural data such as click streams and other user interactions are captured and are denoted as a behavioural data source 101. This is provided as a stream of events data as previously described, each event being either associated with a component on a web page with a unique integer ID, or relating to a user activity. Ultimately, the processed data is provided to a processor for analysing the data and providing a predicted output as previously described. This may be based upon information received from an external source referred to as an actual output stored in a data storage 103 which may comprise external data related to other interactions by the user with the system as a whole. A machine learning module 104 provides learning based on all the data inputs to a storage model 105 which provides an input to the statistical predictor module 102. The derived features from module 108 may also be provided to the machine learning module 104 to improve learning.

The further additional aspects in FIG. 5, not shown in the previous system of FIG. 4, are the selective compressor module 106 which receives the event streams from the client device and provides selective compression, a compressed behavioural data storage 107 which receives the compressed information and a feature calculation module 108 which contains algorithms to take the raw data comprising the event data streams and calculates higher level features such as distributions, averages, maximum values and so on. Such features may be computed in a variety of ways.

The behavioural data may be provided to both the feature calculation module as well as to behaviour data storage 107 as this allows later offline analysis of the raw event data which can be used for developing further training models.

Selective Compression

The event data generated within the client device may be transmitted directly to a remote server for analysis as previous described. However, it is preferred that the event data is selectively compressed prior to transmission. The compression technique used may depend upon the source of the stream of event data and the compression is “selective” in this sense, including selecting no compression where compression is not needed or desired.

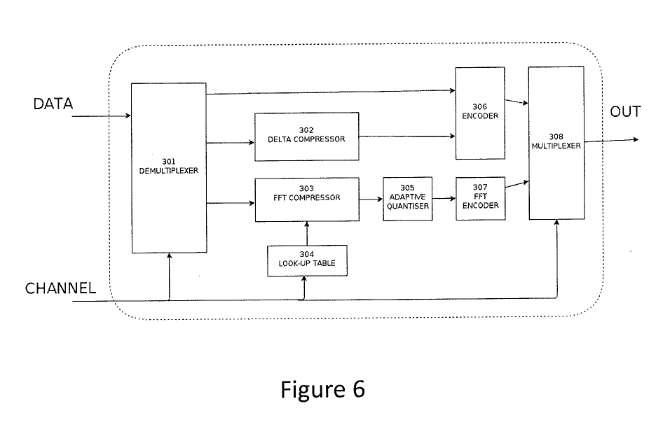

FIG. 6 shows the selective compressor 106 in greater detail. The selective compressor 106 may operate to reduce the bandwidths required by the stream of event data depending upon the nature of the input event data. The feature calculation module 108 may also be within the client device as this aggregates events and therefore reduces the volume of data, but is preferably provided at the server side of the system as is the behavioural data storage module 107 so that the raw event data is available for immediate processing at the remote server and also for any subsequent analysis that the provider of the service is to undertake.

The selective compression system 106 contains intelligence for reducing the size of data depending upon the nature of the input. For example, mouse click event data may require one type of compression whereas event data from movement detectors may require a different type of compression. Furthermore, some types of user interaction may require no compression at all.

Click sensor data is diverse in terms of data's statistical properties, so compression may need to be more diverse and have a way of dealing with different types of data. Sensor data, such as movement sensors, also may contain noise. The selective compression disclosed is able to deal with noise as well.

There are two basic types of sensor data and compression may be optimised for each, namely: continuous data (analog in nature) and discrete data (with events noting a change in reading).

Continuous sensor data includes data such as from an accelerometer, gyroscope or the like and are captured every n milliseconds, allowing frequency based compression to be used. The two compression examples described produce resulting buffers that are 15% of the original size. Optimal thresholds for a low pass filter and also the possibility of multiple filters would suggest sensor-specific filters to be stored in look-up tables.

Discrete sensor data includes sparse events, like orientation, lighting and proximity changes, and do not need to be compressed using this scheme, since they are rare and very quantised at sensor level, so frequency based compression is not likely to help. Sending individual events, as they occur, would be better. As an example, applying frequency compression to data from the light sensor of a user device may actually result in compressed data being larger than the original.

The selective compressor may switch between no compression and compression (and potentially between several types of compression) between sensor data types and aggregate all such ‘sensor channels’ into one stream.

The purpose of the compression system is to reduce the bandwidth required to send the stream of event data from a remote device to a server. The compression is particularly applicable to mobile devices for which there is a bandwidth limitation or cost penalty. The compression can also alleviate some limitations of sampled data, such as inaccurate sampling frequency, discrete nature of sampling and reducing noise from samples. The way in which this is achieved is by a configurable approach which allows different algorithms and parameters to be selected for different types of data, including selecting no compression if compression is not needed. The output is a compressed stream of data having a unified protocol.

The compression unit shown in FIG. 6 has a data stream input for receiving the event data as previously described relating to information from the client device, such as a PC or a mobile device, including items such as mouse movements, accelerometer readings, key strokes, touch events, movement sensors and so on. A channel input comprises a signal to indicate the data type which defines the nature of the data stream. The data type indicates the nature of the source of the data, such as whether it is discrete data such as mouse clicks or analog data such as movement and may also indicate these specific type of sensor used as the input. The data type ID is used as an input to determine how to compress the data.

Demultiplexer 301 provides an output of the event data stream either to a delta compressor 302 or an FFT compressor 303 depending upon the channel selector input. The delta compressor performs delta compression as known to those skilled in the art, namely it provides an output only if the input signal changes.

The FFT compression module provides FFT compression based on parameters passed from a look up table 304 which contains parameters for the compression module selected according to the data channel type which is received as an input to the look up table 304. An adaptive quantizer 305 receives the output from the FFT compressor 303 and finds the optimal size of data in bits for encoding the various bands of frequencies from the FFT compressor 303. This passes data to the FFT encoder 307 which produces packets containing the quantised frequency components.

If FFT compression is not used, then an encoder 306 receives either the uncompressed or the delta compressed streams and outputs the appropriate stream to a multiplexer 308. If the data has been FFT compressed, then the FFT encoder 307 outputs data to the multiplexer 308. The final multiplexer 308 takes any of the sources described and provides a single output stream based on the channel selection signal discussed above.

The event data received may thus be output according to one of three different protocols namely uncompressed, delta compressed or FFT compressed and their selection may be made accordingly to the channel signal identifying the nature of the source of the data.

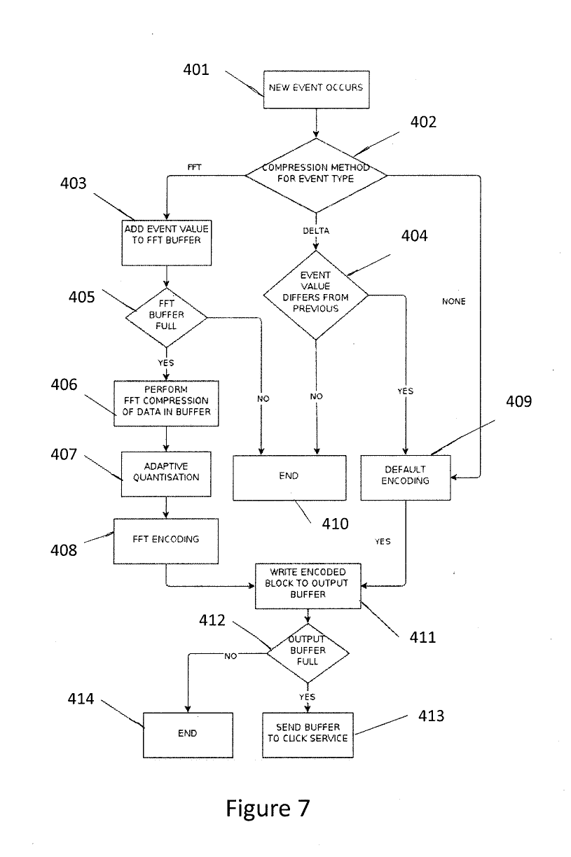

The process for determining whether to compress data is shown in further detail in FIG. 7. When a new event occurs at step 401, this is received by the selective compressor 106 and the compression method for the event type determined at step 402. The determination of the type of compression to be used depends upon the event type based on a lookup table. The type of compression used may be one of three types, namely default encoding with no compression, Delta compression or FFT compression.

If step 402 determines that no compression is needed, then default encoding of the event data into an event stream is performed at step 409. If the type of event indicates that Delta compression should be used, then if the event value differs from the previous value, then default encoding is again used at step 409. The data encoded by either the non-compression method or by Delta compression is then encoded and sent to an output buffer 411. When it is determined that the output buffer is full, the contents of the buffer are transmitted to the remote click service (residing in remote server 4) at step 413.

If the process determines that FFT compression should be used, then the event value is added to an FFT buffer at step 403. The adding of event values to the buffer continues until it is determined that the FFT buffer is full at step 405.

The process then performs FFT compression of the data in the buffer at step 406.

A sequence of events arriving into the selective compressor can be observed as a signal that can be subjected to some established compression methods. Fast Fourier Transform (FFT) is one such method and is used for compressing the stream in this system (selectively for various sensor types, as explained above). Fast Fourier Transform is an optimised algorithmic implementation of the Fourier Transform. Using the Fourier Transform, it can be shown, that a sequence of N sensor value readings:

V₁,V₂, . . . ,Vᵢ, . . . ,V_{N}

captured at equidistant time offsets:

T₁,T₂, . . . ,Tᵢ, . . . ,T_{N}(T₂−T₁=T₃−T₂= . . . =T_{N}−T_{N-1})

can be transformed into a sequence of coefficients [a(wi),b(wi)] of decreasing relevance for reconstructing the original signal. The system uses a single integer number (M<N) to specify the point after which the coefficients are not transmitted, implementing effectively a low-pass filter. This parameter is configured and potentially different for different sensor types, so effectively, one of several preconfigured low-pass filters is being applied for each sensor type.

Subsequently, at step 407, adaptive quantisation is performed.

The coefficients produced by the FFT module can be of very different magnitudes for a single compressed sequence of sensor readings. The magnitudes can differ by several orders of magnitude. The magnitude of the coefficients tends to decrease as the index of the coefficient grows, with the first coefficient pair having usually the largest magnitude, often several orders of magnitude larger than coefficients with a higher index (and lower relevance in reconstruction). This is why it is useful to represent different ranges of coefficients with a different number of bytes. For example, the first few coefficients could require 3 bytes to fully represent their value with sufficient precision, but only 1 byte for higher coefficients.

This is why adaptive quantisation is preferably used—the algorithm reads the coefficients produced by the FFT module, and applies the following formula when estimating the number of bits needed for representing the coefficient:

N_{bits}=floor(log₂(abs(max(a,b)))+2)

N_{bytes}=(N_{bits}+8)div 8

Here, floor is the function of removing the decimal points from the argument and div is the integer division. The adding of 2 is to allow for doubling the size and to accommodate for the sign, since the coefficients can be negative and are represented in the complement of 2 multi-byte encoding. This number of bits is then extended to the closest multiple of 8, to get the number of bytes needed. Further, the input to the algorithm are two integer thresholds (B1 and B2) that split the sequence output of FFT into 4 bands, each of which is processed with the above algorithm, to produce 4 byte lengths for encoding the coefficients. The four bands are defined as follows (specifying the coefficient pairs contained in them, inclusive):

Band 1: [a(w₀),b(w₀)]

Band 2: [a(w₁),b(w₁)]−[a(w_{B1}),b(w_{B1})]

Band 3: [a(w_{B1}),b(w_{B1})]−[a(w_{B2}),b(w_{B2})]

Band 4: [a(w_{B2}),b(w_{B2})]−[a(w_{M}),b(w_{M})]

One N_{bytes} length integer is produced for each of the four bands, and these are named QC1, QC2, QC3 and QC4 in the following descriptions. Since the encoded coefficients are represented as a sequence of bytes, it is critical to transmit these coefficients as well, in order to allow for successful decoding of the signal.

Lastly, FFT encoding is performed at step 408.

After the FFT compression and quantisation steps, the data is encoded. The values B1, B2, QC1, QC2, QC3, QC4 are added as parameters to the packet, along with two more parameters: TimeOffsetEnd and Size. TimeOffsetEnd notes the TimeOffset parameter of the last compressed event and the Size parameter notes the size of the original sequence that the decoder is to reconstruct from the transmitted coefficients. The actual M coefficients, being represented as a sequence of bytes, according to the above quantisation scheme are then hex-encoded, where every byte is encoded with two characters, as per conventional hexadecimal scheme.

For example, for quantizing and encoding a single real number using the above scheme, the coefficient pair (−12432,0), we get Nbytes=2. −12432 represented with two bytes is: 120,207, where the lowest byte is first the sequence. Then, encoding this 2-byte sequence into a hexadecimal string produces: CF78 (CF for 207 and 78 for 120). A large such string is produced for all coefficients, across all bands and added as the last parameter in the encoded packet.

The output of the FFT encoding is provided to the output buffer 412 as before and, when the buffer is full, the buffer content is sent to the remote service. If the buffer is not full, the process ends 414 awaiting further data.

Examples of the output of the selective compression will now be described for completeness.

Uncompressed Packet Structure

| | | | | | |
|---|---|---|---|---|---|
| type | time- | componentID | componentName | eventID | PARAMS |
| | Offset | | | | |

type=1
timeOffset—offset in milliseconds since session (page load) start
componentID—ID of the component where the event is occurring
componentName—string representation of the component
eventID—ID of the event
PARAMS—parameters for this event, variable content—depending on eventID

Uncompressed Example:

| | time- | | | | |
|---|---|---|---|---|---|
| type | Offset | componentID | componentName | eventID | PARAMS |
| 1 | 2760 | 32 | inputName01 | 9 | 65, 122 |

type=1—uncompressed data
timeOffset=2760—event occurring 2760 ms after page load
componentID=32—event occurring on component with ID=32
componentName=inputName01, the name of the component
eventID=9, the ‘key release’ event
PARAMS=
   65—key code for character ‘a’
   122—duration of time (in milliseconds) the character was pressed, before the key release event

Delta Compression

The format is the same as for uncompressed data (but with type=2), but assuming that the event is sent upon change, so that, in between events, it is assumed the reading is at previous value, which is unlike uncompressed data which samples individual events and does not make assumptions about the values in between events.

Delta Compression Example:

| | time- | | | | |
|---|---|---|---|---|---|
| type | Offset | componentID | componentName | eventID | PARAMS |
| 2 | 3500 | 0 | | 21 | 1000 |
| 2 | 8900 | 0 | | 21 | 100 |

type=1
timeOffset=3500,8900—noting two events sent, each at time when the reading changes
componentID=0, componentName=<empty>, not used by eventID
eventID=21, light sensor
PARAMS=1000,100—noting a change in reading from 1000 to 100 at timeOffset=8900

FFT Compressed Packet Structure

| | | | | | | | |
|---|---|---|---|---|---|---|---|
| type | timeOffset | componentID | componentName | eventID | channelID | timeOffsetEnd | Size |

type=3
timeOffset—offset in milliseconds since session (page load) start
componentID—ID of the component where the event is occurring
componentName—string representation of the component
eventID—ID of the event (e.g. 19 for accelerometer)
channelID—channel of ID (e.g. 0 or 1 for touch events for X and Y coordinates)
timeOffsetEnd—timeOffset of the last event contained in PARAMS
Size—number of events in the uncompressed array

| | | | | | | |
|---|---|---|---|---|---|---|
| B1 | B2 | QC1 | QC2 | QC3 | QC4 | PARAMS |

B1,B2—bands that segment the spectrum into sections, each with a different number of bytes used for encoding the coefficients PARAM
QC1—number of bytes used for encoding the first coefficient pair in PARAMS
QC2—number of bytes used for encoding the next B1 coefficient pairs in PARAMS
QC3—number of bytes used for encoding the next B2 coefficient pairs in PARAMS
PARAMS—sequence of hex-encoded bytes, containing the encoded coefficient pairs. These pairs may be represented with multiple bytes per component, which are ordered in little endian order.

FFT Compression Example:

| type | timeOffset | componentID | componentName | eventID | channelID | timeOffsetEnd | Size |
|---|---|---|---|---|---|---|---|
| 3 | 10857 | 0 | | 19 | 0 | 11857 | 256 |

Type=3 (compressed)
TimeOffset=10857=10.857 seconds after page load
component ID=0 (default element)
componentName=not defined
eventID=19 (accelerometer reading)
channelID=0, rotation around X-axis
timeOffsetEnd—time offset of last element in the compressed block
Size—number of compressed events

| B1 | B2 | QC1 | QC2 | QC3 | QC4 |
|---|---|---|---|---|---|
| 20 | 8 | 3 | 2 | 2 | 2 |

B1=20, first band=20 coefficient pairs
B2=8, second band=8 coefficient pairs
QC1=3: first coefficient pair compressed with 3 bytes
QC2=2: pairs 2-21 inclusive (total of B1=first band) encoded with 2 bytes each
QC3=2: pairs 22-30 inclusive (total of B2=second band) encoded with 2 bytes each
QC4=4: the remaining coefficient pairs encoded with 2 bytes each

PARAMS

3c7802000000c80983eddea2fcbc10447f35c9e7c3154a2592faadf2590fe708
f01f09ed032121e30b1b4df544e98df4991425f5b00155ed6a11bef5390ea7f3
a50d5a00a20d71fe090ea0fe020e9cfc0e07fe021303ce02e9017bff4dfc16ff
1af8b8f880ff79f71c0561f7f6086704f407eafe86014effe800

Hex encoded string representing the coefficient pairs. As visible, the first coefficient pair (encoded with 3 bytes each, for a total 6 bytes) is 3c7802000000. The latter six zeroes represent the second pair, which for the case of the first coefficient is always zero. When decoding the hex representation (using little endian ordering of bytes), we get that this corresponds to a complex pair (161852,0). The second pair, belonging to band B1 and therefore encoded with 2 bytes each is c80983ed, corresponding to (2504, 60803).

1. A method for monitoring the interaction of a user using a client device with a page of a remote server, the client device including at least one processor, at least one memory and at a least one computer program stored in at least one of the memories, the at least one computer program being executable on at least one of the processors, the process comprising:
the at least one processor causing the client device to:
record user interactions with components on the page of the remote server;
extract for each interaction a unique ID value for the component with which the interaction occurred;
create event data derived from each interaction, the data comprising the unique ID value and at least a time value for each interaction; and
transmit the event data as a stream to the remote server.

2. A method according to claim 1, wherein the unique ID comprises an extension to the markup language of each component.

3. A method according to claim 1, wherein each event comprises the unique ID, timestamp and ID of the component.

4. A method according to claim 1, wherein the component is an element within the document model of the page.

5. A method according to claim 1, further comprising deriving at the client device one or more features from the event data.

6. A method according to claim 5, wherein the method allows or denies access to remote servers based on the derived features.

7. A method according to claim 1, further comprising selectively compressing the event data prior to transmission.

8. A method according to claim 7, wherein the selective compression for multiple events uses frequency analysis.

9. A method for monitoring the interaction of a user using a client device with a page of a remote server, the client device including at least one processor, at least one memory and at a least one computer program stored in at least one of the memories, the at least one computer program being executable on at least one of the processors, the process comprising:
the at least one processor causing the client device to allow:
a user of the client device to interact with a page of a remote server;
monitor the interaction of the user with the page of a remote server;
record user interactions with components on the page of the remote server;
extract for each interaction a unique ID value for the component with which the interaction occurred;
create event data derived from each interaction, the event data comprising the unique ID value and at least a time value for each interaction; and
transmit the event data as a stream to the remote server.

10. A client device according to claim 9, wherein the unique ID comprises an extension to the markup language of each component.

11. A client device according to claim 10, wherein each event comprises the unique ID, timestamp and ID of the component.

12. A client device according claim 9, wherein each component with which the interaction occurred is an element within the document model of the page.

13. A client device according to claim 9, further comprising means for deriving at the client device one or more features from the event data.

14. A client device according to claim 13, wherein the client device allows or denies access to remote servers based on the derived features.

15. A client device according to claim 9, further comprising a compressor which selectively compresses the event data prior to transmission.

16. A client device according to claim 15, wherein the selective compression for multiple events uses frequency analysis.

17. A computer system comprising at least one processor, at least one memory and at least one program stored in at least one of the memories, at least one page stored in at least one of the memories, the at least one program, when ran on at least one of the processors, operating to:
at the request of a remote client device, retrieve a page stored in at least one of the memories and allocate a unique ID to each component on the page;
transmit the page and allocated unique IDs to the client device; and
provide code to the client device which, when executed, undertakes the steps of:
recording user interactions with components on the page of the computer system;
extracting for each interaction the unique ID value for the component with which the interaction occurred;
creating event data derived from each interaction, the data comprising the unique ID value and at least a time value for each interaction; and
transmitting the event data as a stream to the computer system.

18. A system according to claim 17, wherein the unique ID comprises an extension to the markup language of each component.

19. A system according to claim 17, wherein the means for retrieving the page and allocating unique IDs comprises code operable in receipt of a user request to retrieve the page.

20. A system according to claim 17, wherein the remote server further comprises means for deriving one or more features from the event data.

21. A system according to claim 20, wherein the remote server allows or denies access to remote servers based on the derived features.

22. A non-transitory computer readable medium having a program stored therein, the program, when executed on one or more processors of a computerized client device, causes the client computer to:
record user interactions with components on a page of a remote server;
extract for each interaction a unique ID value for the component with which the interaction occurred;
create event data derived from each interaction, the data comprising the unique ID value and at least a time value for each interaction; and
transmit the event data as a stream to the remote server.

23. A method for monitoring the interaction of a user using a client device with a page of a remote server, the client device including at least one processor, at least one memory and at a least one computer program stored in at least one of the memories, the at least one computer program being executable on at least one of the processors allowing a user of the client device to interact with a page of a remote server, at least one sensor detecting how the user uses the client device, the method comprising the client device:
recording interactions of the client device while the user the device displays a page of the remote server;
creating event data derived from each interaction, the event data comprising an event ID, event type and a time value;
encoding the event data according to one of a plurality of encoding schemes depending upon the event type, at least one of the plurality of encoding schemes comprising compressing the event data according to a compression scheme; and
transmitting the event data as a stream to the remote server.

24. A method according to claim 23, wherein, at least one sensor is used to detect the user interaction recorded by the client device and for each recorded user interaction the event type is determined according to the nature of the sensor used to detect the user interaction.

25. A method according to claim 24, wherein the event type indicates whether the sensor records continuous data or discrete data.

26. A method according to claim 23, wherein the compression scheme comprises frequency compression.

27. A method according to claim 23, wherein the encoding comprises using frequency compression for continuous data.

28. A method according to claim 27, wherein the frequency compression comprises lossy FFT compression.

29. A method according to claim 23, wherein frequency compression is used where the sensor of the client device used to detect the user interaction is a motion sensor.

30. A client device operable to monitor user interaction with a page of a remote server and transmitting data to the remote server, the client device comprising a display, at least one sensor detecting how the user uses the client device, at least one processor, at least one memory and at a least one computer program stored in at least one of the memories, the at least one computer program, being executable on at least one of the processors and causing the client device to:

31 allow a user of the client device to interact with a page of a remote server;
record interactions of the user of the client device with the client device while the user the device displays a page of the remote server on the display;
create event data derived from each interaction, the event data comprising an event ID, event type and a time value;
encode the event data according to one of a plurality of encoding schemes depending upon the event type, at least one of the plurality of encoding schemes comprising compressing the event data according to a compression scheme; and
transmitting the event data as a stream to the remote server.

32. A client device according to claim 30, wherein the event type is determined according to the nature of the sensor of the client device used to detect the user interaction.

33. A client device according to claim 31, wherein the event type indicates whether the sensor records continuous data or discrete data.

34. A client device according to claim 30, wherein the compression scheme comprises frequency compression.

35. A client device according to claim 30, wherein the encoding comprises using frequency compression for continuous data.

36. A client device according to claim 34, wherein the frequency compression comprises lossy FFT compression.

37. A client device according to claim 30, wherein frequency compression is used where the sensor of the client device used to detect the user interaction is a motion sensor.
